(19) United States
(12) Patent Application Publication
(10) Pub. No.: US 2011/0182078 A1
(43) Pub. Date: Jul. 28, 2011

(54) LED cradle

(75) Inventor: Brian Brandes, Brentwood, NY (US)

(73) Assignee: SATCO PRODUCTS, INC.

(21) Appl. No.: 12/657,540

(22) Filed: Jan. 22, 2010

(51) Int. Cl. F21V 21/00

(52) U.S. Cl. 362/382

(57) ABSTRACT

An LED cradle for an LED module, said module comprising an LED board, heat sink and a driver.

### FIELD OF THE INVENTION

The present invention relates to an LED cradle for an LED module, said module comprising an LED board, heat sink and a driver.

### BACKGROUND OF THE INVENTION

U.S. Pat. No. 5,601,358 relates to a power pack having compartments for holding at least one battery and electrical components for controlling at least one lighting element, which includes a snap-on cover for enabling the power pack to be assembled to a wide variety of surfaces and electrical terminal structures for mounting a variety of different lighting elements. These include both electro-luminescent strips and light emitting diode fixtures.

U.S. Pat. No. 6,991,350 relates to a housing for an LED fixture and soffit lighting system. The device comprises a housing for a lighting source, the housing having an outer shroud, a front edge, a hollow inner surface, and an inner shroud. The inner shroud has a front edge and a concentric bore within which the light source is affixed.

U.S. Pat. No. 7,198,386 relates to a thermally advanced LED fixture. The device overcomes the problems with MCPCB technology which includes conductive solid body, copper or aluminum, having rods extending therefrom. Each LED is mounted to a standard printed circuit board or flexible circuit board that contains through holes large enough to fit the metal bottom of the LED through the hole far enough from the LED to make contact with the face of the solid body. The LED is glued to the face solid body via a thermally conductive electrically neutral adhesive. The LED may also be adhered via thermal tape, thermal pad, or held against the solid body via its solder joints where no bonding of the LED is required.

U.S. Pat. No. 7,234,842 relates to a replaceable LED socket torch and lighting head assembly. A replaceable lighting head assembly is comprised of a high output LED socket torch package, vertically aligned thermal heat sink, and electrical connector coupled with a secondary housing unit that conducts heat received from the heat sink to the external environment and acts as a conduit for the external electrical source. This serves as a building block for further fixture design.

US Patent Pub. No. 2008/0266843 relates to an LED ceiling tile combination, which includes a ceiling having at least one LED fixture integrated therewith. The LED fixture can include at least one LED, and a support structure for at least one LED strip.

US Patent Pub. No. 2008/0278941 relates to an LED based lighting apparatus in which mechanical and/or thermal coupling between respective components is accomplished via a transfer of force from one component to another. In one example, a multiple-LED assembly is disposed in thermal communication with a heat sink that forms part of a housing. A primary optical element within a pressure-transfer member is disposed above and optically aligned with each LED. A shared secondary optical facility forming another part of a housing is disposed of above and compressively coupled to the pressure-transfer members. A force exerted by the second optical facility is transferred via the pressure-transfer members so as to press the LED assembly toward the heat sink, facilitating heat transfer.

US Patent Pub No. 2009/0080189 relates to an optic coupler for a light emitting diode fixture. A recessed light fixture includes an LED module, which includes a single LED package that generates all light emitted by the recessed light fixture. The LED package can include multiple LEDs mounted to a common substrate. The LED package can be coupled to a heat sink. The heat sink can include a core member from which fins extend. A reflector housing may be coupled to the heat sink and configured to receive a reflector. An optic coupler can be coupled to the reflector housing to cover electrical connections at the substrate and guide light emitted by the LED package.

US Patent Pub No. 2009/0086476 relates to a light emitting diode recessed light fixture. The recessed light fixture includes an LED module, which includes a single LED package that generates all light emitted by the recessed light fixture. The LED package can include multiple LEDs mounted to a common substrate. The LED package can be coupled to a heat sink for dissipating heat from the LEDs. The heat sink can include a core member from which fins extend. A reflector housing may be coupled to the heat sink and configured to receive a reflector. An optic coupled can be coupled to the reflector housing and cover electrical connections at the substrate and guide light emitted by the LED package.

US Patent Pub. No. 2009/0267540 relates to a modular lighting system of LED based lighting systems. The LED lighting systems may include fixtures with one or more rotatable LED light bars, integrated sensors, on board intelligence to receive signals from the LED light bulbs and control the LED light bulbs, and a mesh network connectivity to other fixtures.

LED lighting fixtures that are currently sold in the market utilize three components: LED PC board, electronic current driver, and heat sink. These components are designed specifically for each lighting fixture and are installed as non-serviceable, non-replaceable devices. Should there be a product failure or the need to change the performance of the LED, the entire fixture would need to be replaced.

### SUMMARY OF THE INVENTION

The present invention relates to a replaceable snap in and out all in one LED module. The present invention uses an existing all in one LED module, a module comprising an LED board, heat sink and driver. The LED cradle is physically attached to a fixture body. The LED module is physically attached to the cradle. The present invention relates to a cradle device which integrates into lighting fixtures as a retrofit device or as original equipment in manufacturing.

It is an object of the present invention for the cradle to be used in place of standard incandescent or fluorescent sockets and snapped onto the fixture body.

It is an object of the present invention for the cradle to comprise two pieces. It is an object of the present invention for the LED module to comprise three pieces. It is an object of the present invention for the cradle to comprise slotting and vent holes to create air flowing through the LED module.

The cradle of the present invention is designed to allow a jumper cable from the electrical box to be plugged into the male power in the connector on the cradle. It is an object of the present invention for the cradle to feature a bypass circuit which allows multiple cradle devices to be fed power from one cradle at the source of power.

It is an object of the present invention for the cradle to have a universal mounting system which allows the device to be used in existing fixtures without modification to the tooling or the manner in which the fixture is installed.

It is an object of the present invention for the cradle to be positioned over standard mounting holes so all mechanical and electrical connections are made.

It is an object of the present invention for the cradle to comprise a finishing plate which covers the connections.

It is an object of the present invention for the all in one device to snap into the cradle making a physical locking connection.

It is an object of the present invention for the locking connection to be released by a spring loaded trigger latch.

It is an object of the present invention for electrical connections to be made via recessed contacts in the cradle and a protruding contact in the all in one module.

It is an object of the present invention for the cradle to be manufactured in a variety of sizes and configurations based on the size, application, and light out put requirements of the lighting fixture.

It is an object of the present invention for the cradle to be configured with additional contacts which allow for RGB (red green blue) LED color changing controllers to be used and/or intelligent lighting/home automation systems which can control the device.

### BRIEF DESCRIPTION OF THE DRAWINGS

FIG. 1 shows a schematic representation of the device.

FIGS. 2a, 2b, 2c, 2d show four all-in-one module designs.

FIG. 3a shows a top internal view of the all-in-one module.

FIG. 3b shows a top view of the all-in-one module.

FIG. 3c shows a top internal view of the all-in-one module.

FIG. 3d shows a top view of the all-in-one module.

FIG. 4a shows a top view of the cradle design.

FIG. 4b shows a bottom view of the cradle design.

FIG. 5a shows a top view of the cradle design.

FIG. 5b shows a bottom view of the cradle design.

FIG. 6a shows a top view of the cradle design.

FIG. 6b shows a bottom view of the cradle design.

FIG. 7 relates to a cradle having the all-in-one module attached to it.

FIG. 8 shows various views of the LED module and cradle.

FIG. 9 is a side view of the cradle device.

FIG. 10 is a side view of the cradle device with a LED module.

FIG. 11 shows a tab design for the cradle of the present invention.

FIG. 12 shows a cradle of the present invention.

FIG. 13 shows a cradle of the present invention.

FIG. 14 shows a cradle of the present invention.

FIG. 15 is a LED module attached to the finished cradle.

FIG. 16 shows a cradle of the present invention.

FIG. 17 shows an LED module.

FIG. 18 shows an electrical contact component.

FIG. 19 shows a side view of the LED module.

FIG. 20 shows a top view of the LED module.

FIG. 21 shows an electrical contact component.

### DETAILED DESCRIPTION

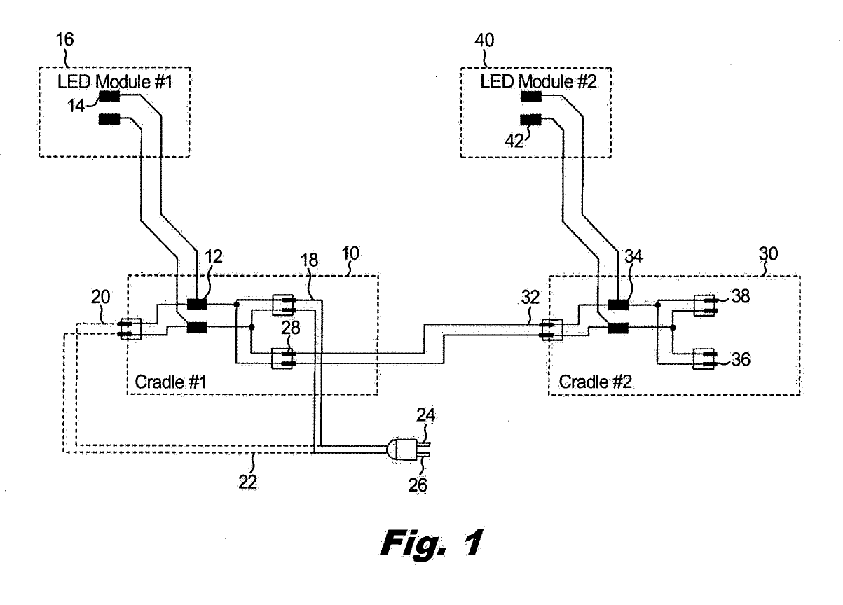

FIG. 1 shows a cradle 10, having contacts 12 which connect to contacts 14 of LED module 16. Cradle 12 has a primary input connector 18 and a secondary input connector 20. Cradle 10 has an optional connection via external wiring 22 to an input 24 and power 26. Cradle 10 can be connected to cradle 30 via a secondary input connector 32 which is corrected to bypass connector 28 of cradle 10. Cradle 30 has contacts 34, a bypass connector 36 and a primary input connector 38. Cradle 30 is connected to LED module 40 between LED module contact 42 and cradle contacts 34.

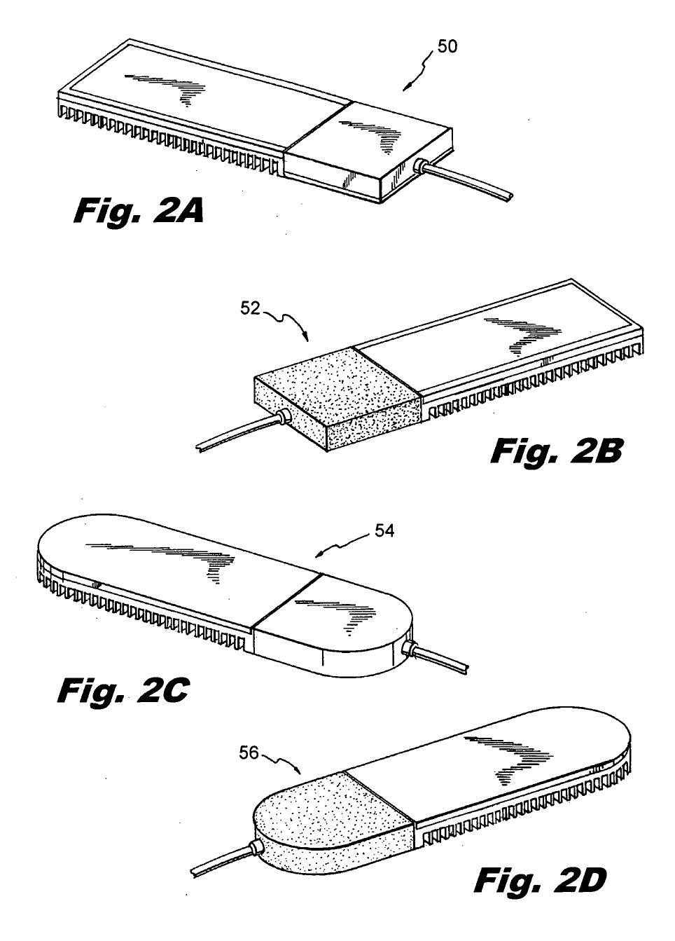

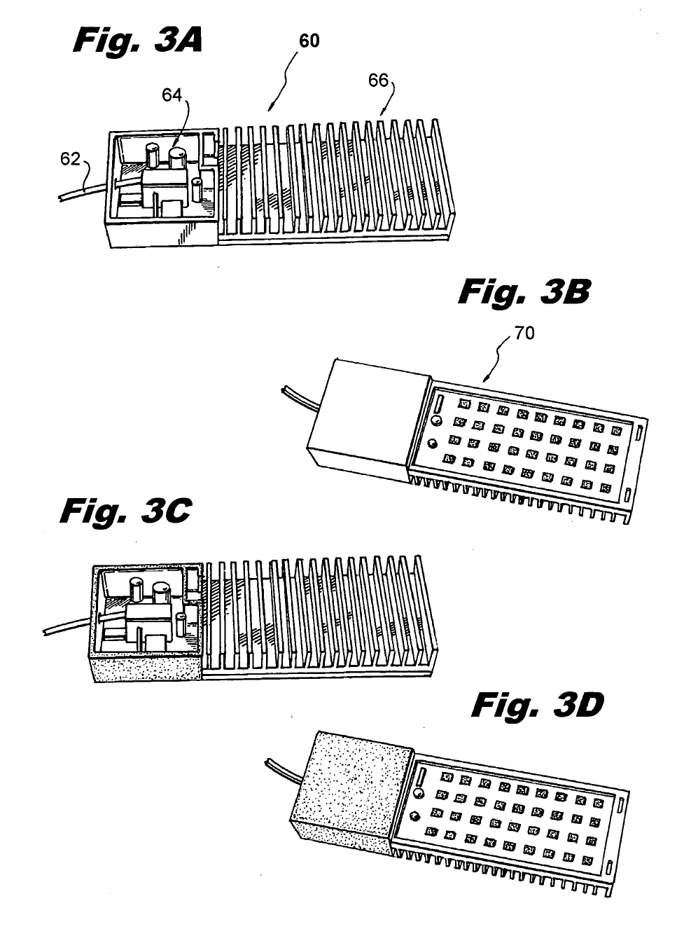

FIGS. 2a, 2b, 2c, 2d all show the LED modules 50, 52, 54, 56 of the present invention.

FIG. 3a shows the LED module 60 having the power feed 62 driver 64 and the heat sink 66. The driver 64 can be a transformer or ballast which controls the current to the LED board 70 shown in FIG. 3b.

FIGS. 3c, 3d show other views of what is shown in FIGS. 3a, 3b.

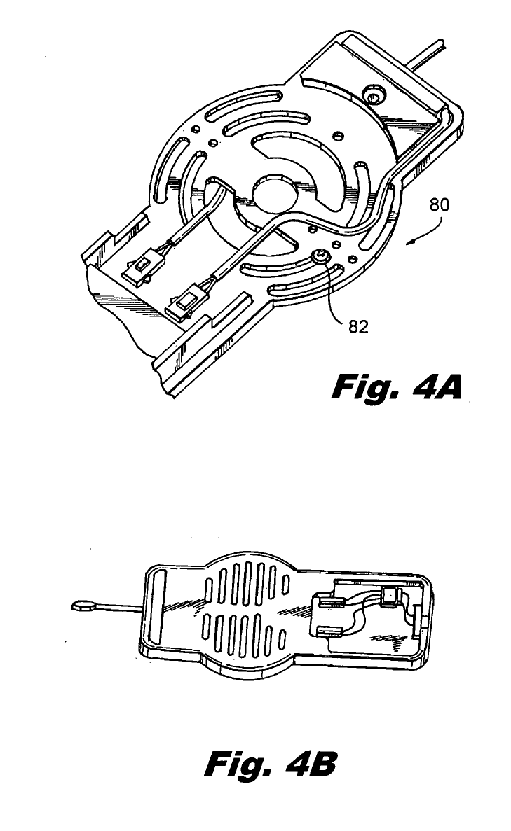

FIGS. 4a and 4b show the cradle 80, the cradle 80 has grounding screw 82.

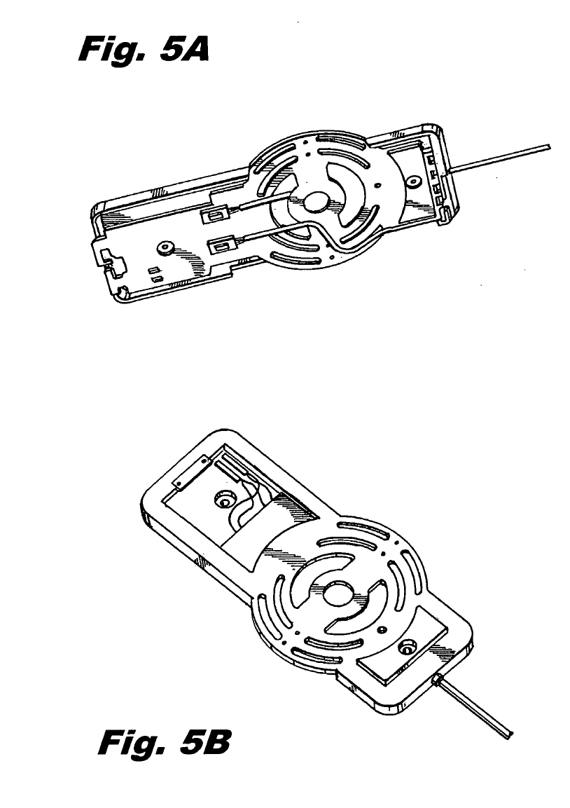

FIGS. 5a and 5b show other views of the cradle 80 of the present invention.

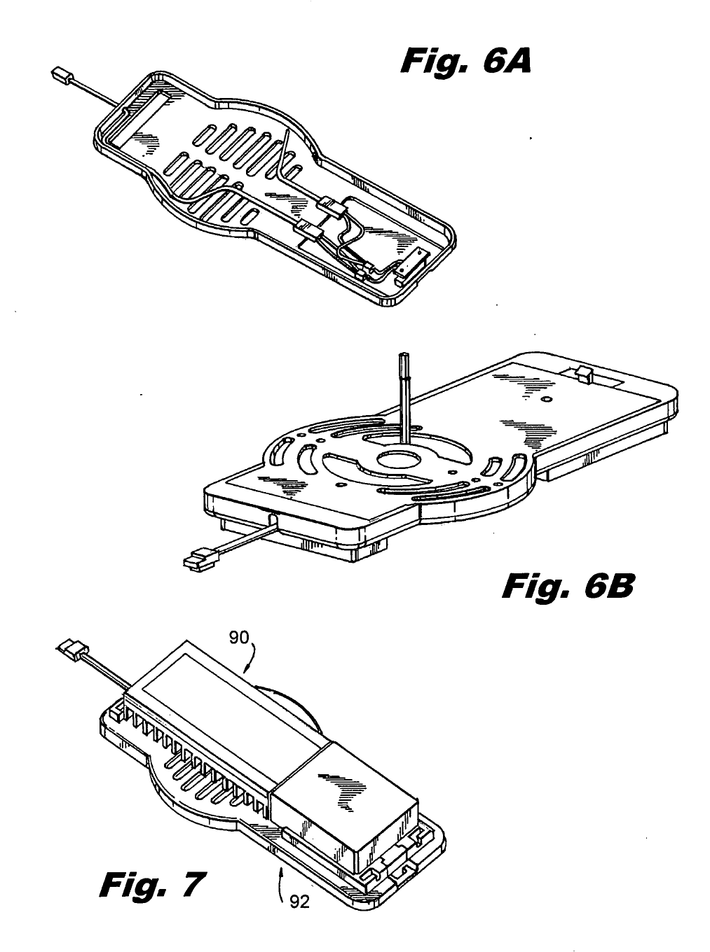

FIGS. 6a and 6b also show other views of the cradle 80 of the present invention.

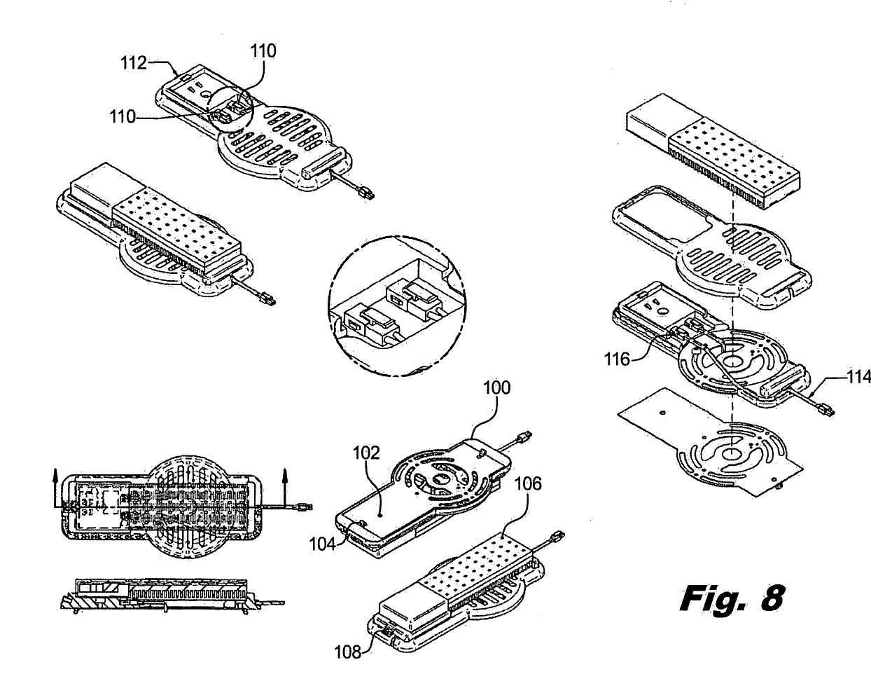

FIG. 7 shows an LED module 90 physically attached to the cradle 92.

FIG. 8 shows the cradle 100 having a screw hole 102 and a snap-in 104. The LED module 106 is placed on the cradle 100. The cradle further has a connector 108 which can be plugged in with other wiring. The cradle has bypass connectors 110 and a secondary input connector 112, the cradle has an optional bypass cable 114 and has a bypass circuit power out 116 and a bypass circuit 118 which connects to an electrical box to power the device.

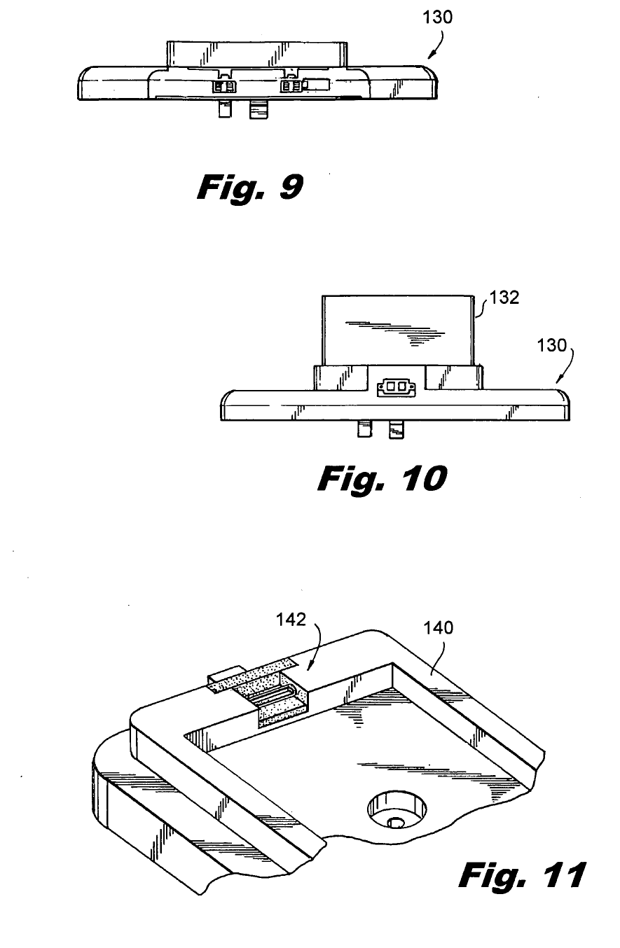

FIG. 9 shows the extended width of the slot of the cradle 130.

FIG. 10 shows the extended width of the slot of cradle 130 to accommodate LED module 132.

FIG. 11 shows cradle 140 having a tab 142 designed with an integrated stopper to assist in holding the LED module in place.

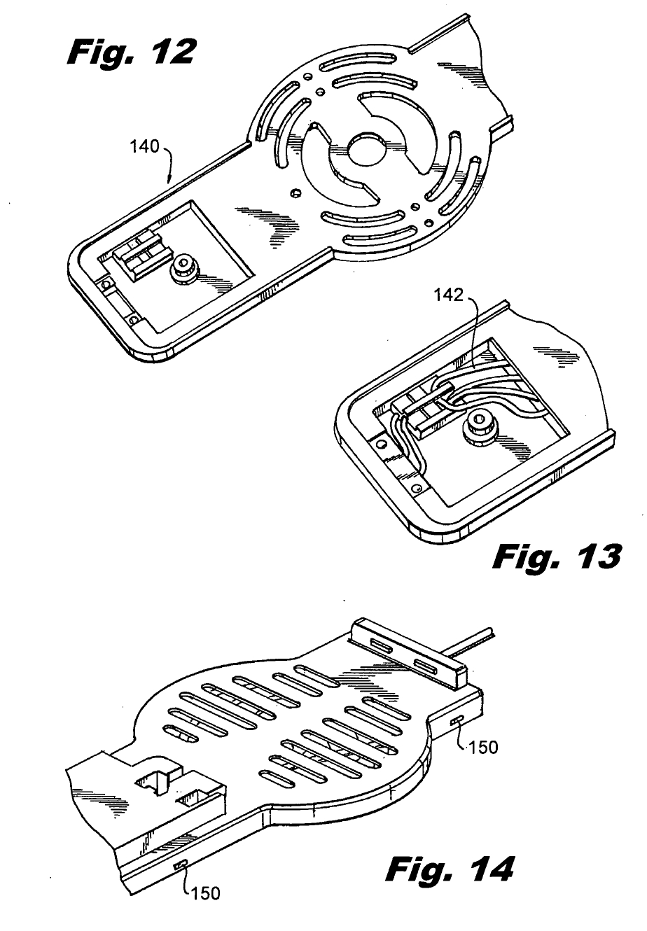

FIG. 12 shows a plastic cradle 140.

FIG. 13 shows wiring 142 of the cradle 140 of the present invention.

FIG. 14 shows a shell designed to fix onto the cradle by four clips 150.

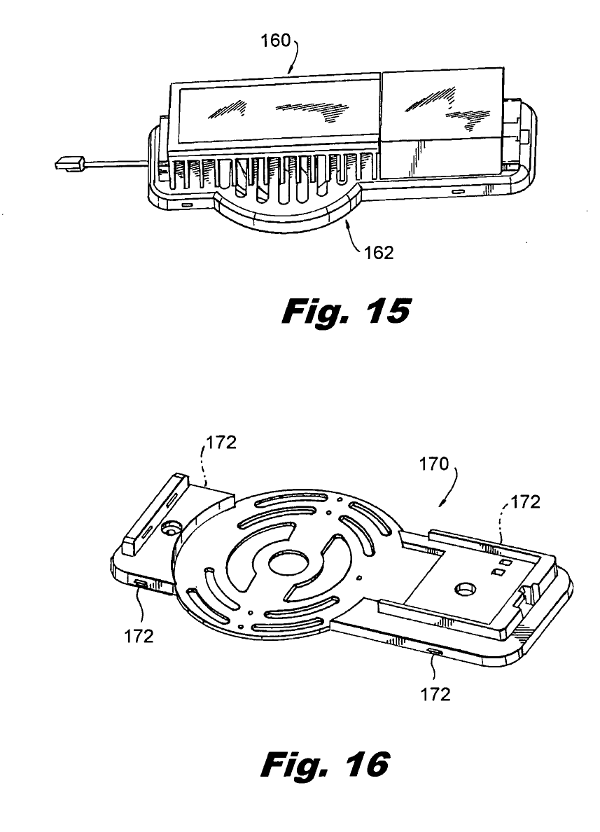

FIG. 15 shows LED module 160 attached onto cradle 162.

FIG. 16 shows a cradle 170 having upturned lugs 172.

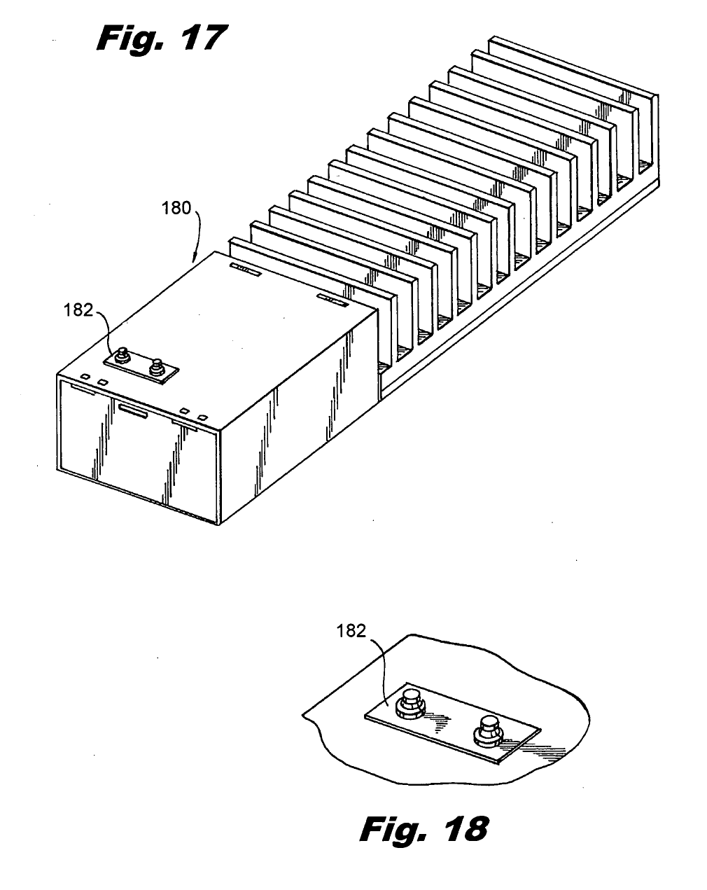

FIG. 17 shows LED module 180 having electrical component 182.

FIG. 18 shows electrical contact component 182.

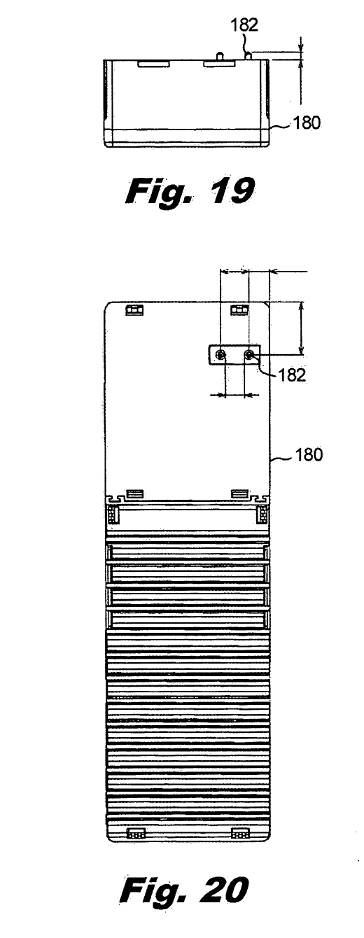

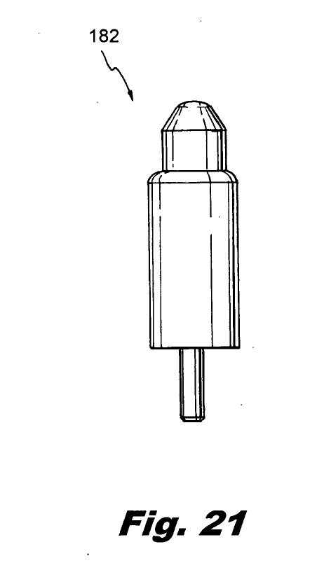

FIGS. 19 and 20 show a LED module 180, having electrical contact components 182.

FIG. 21 shows electrical contact component 182.

The present invention relates to a replaceable snap in and out all in one LED module attached to a cradle. The invention uses an existing all in one LED module, a module comprising an LED board, heat sink and driver. A cradle device integrates into lighting fixtures as a retrofit device or as original equipment in manufacturing.

In an embodiment, the cradle is used in place of standard incandescent or fluorescent sockets and is snapped onto the fixture body.

The cradle allows a jumper cable from the electrical box to be plugged into the male power in the connector on the cradle. In an embodiment, the cradle features a bypass circuit which allows multiple cradle devices to be fed power from one cradle at the source of power.

In an embodiment, the cradle has a universal mounting system which allows the device to be used in existing fixtures without modification to the tooling or the manner in which the fixture is installed.

In an embodiment, the cradle is positioned over standard mounting holes and allows for all mechanical and electrical connections to be made.

In an embodiment, the cradle comprises a finishing plate which covers the connections. In an embodiment, the all in one device snaps into the cradle making a physical locking connection. In an embodiment, once the device snaps in making a locking connection, the locking connection is released by a spring loaded trigger latch.

In an embodiment, electrical connections are made via recessed contacts in the cradle and a protruding contact in the all in one module.

The cradle is manufactured in a variety of sizes and configurations based on the size, application, and light out put requirements of the lighting fixture.

In an embodiment, the cradle is configured with additional contacts which allow for RGB LED color changing controllers to be used and/or intelligent lighting/home automation systems which control the device.

The cradle can be used on a RGB (red, green, blue) lighting which can make white light and mix any color. The LED device can be a traditional phosphor product which produces white light. The cradle does not prohibit the mounting of a fixture in a traditional way. One does not have to retool the fixture to fit the LED. The device has a universal crossbar which fits into any electrical box.

In an embodiment, the width of the LED module is wider than the slot width on the cradle.

1. An LED cradle device comprising:
a cradle for an LED module;
said LED module comprising an LED board, heat sink, and a driver;
said LED cradle physically attached to a fixture body;
said LED module physically attached to said cradle.

2. The device of claim 1 wherein said LED module snaps in and out of said LED cradle.

3. The device of claim 1 wherein no wiring is used to attach said LED module to said cradle.

4. The device of claim 1 wherein said cradle comprises 2 pieces.

5. The device of claim 1 wherein said LED module comprises 3 pieces.

6. The device of claim 1 wherein said cradle comprises slotting and vent holes.

7. The device of claim 6 wherein said slotting and vent holes creates air flowing through said LED module.

8. The device of claim 1 wherein said cradle has its own circuits to feed said LED module.

9. The device of claim 1 wherein said cradle integrates into lighting fixtures as a retrofit or as original equipment.

10. The device of claim 1 wherein said cradle is used in place of standard incandescent or fluorescent sockets.

11. The device of claim 1 further comprising a jumper cable from an electrical box plugged into a male power in connector on said cradle.

12. The device of claim 1 further comprising a bypass circuit for multiple cradle devices to be fed power from one cradle at source of power.

13. The device of claim 12 wherein said bypass circuit comprises a female connector to feed further LED modules.

14. The device of claim 1 further comprising a universal mounting system

15. The device of claim 9 wherein said device is used in existing fixtures without modification to tooling or manner in which device is installed.

16. The device of claim 1 wherein said cradle is positioned over standard mounting holes for all mechanical and electrical connections to be made.

17. The device of claim 1 further comprising a finishing plate which covers connections.

18. The device of claim 1 wherein said LED module snaps into said cradle making a physical locking connection.

19. The device of claim 18 wherein said locking connection is released by a spring loaded trigger latch.

20. The device of claim 1 wherein electrical connections are made via recessed contacts in said cradle and a protruding contact in said LED module.

21. The device of claim 1 wherein said cradle is configured with additional contacts.

22. The device of claim 21 wherein said contacts allow for RGB, red green blue, LED color changing controllers to be used and/or intelligent lighting/home automation systems which control said device.

23. The device of claim 1 wherein said cradle comprises two contacts that snap in place and light up said LED.

24. The device of claim 23 wherein electrical contact components of said LED module comprise brass plungers.

25. The device of claim 24 wherein said electrical contact components snap in and make contact with female contacts in said cradle.
